(19) United States
(12) Patent Application Publication
(10) Pub. No.: US 2006/0078080 A1
(43) Pub. Date: Apr. 13, 2006

(54) Small diameter bore pressure vessel penetration modification

(76) Inventors: Ronal J. Payne, Forest, VA (US); Dave E. Waskey, Bedford, VA (US); Stephen J. Rapiejko, Lynchburg, VA (US)

Correspondence Address: VYTAS R. MATAS, 2412 CEDARWOOD RD., PEPPER PIKE, OH, 44124, US

(21) Appl. No.: 11/045,964

(22) Filed: Jan. 27, 2005

Related U.S. Application Data
(60) Provisional application No. 60/617,024, filed on Oct. 8, 2004.

(51) Int. Cl. G21C 13/00

(52) U.S. Cl. 376/204

(57) ABSTRACT

The present invention discloses a system for repairing small internal diameter (1.24 in. or less) Inconel 600 bottom mounted nozzles on reactor pressure vessels. The system enlarges the original small diameter nozzle bore to a larger size and ads a larger ID Inconel 600 replacement nozzle therein which allows IDST weld tooling to be inserted to weld the replacement nozzle to thereactor vessel. An Inconel 600 sleeve of the original small ID tubing is inserted in the replacement nozzle and welded to the replacement nozzle to restore the operability of the original tube.

### BACKGROUND OF THE INVENTION

1. Field of the Invention

The present invention is generally drawn to nozzle repair on pressure vessels and more particularly to the repair of small diameter bottom mounted reactor nozzles.

2. Description of the Prior Art

Known repair methods for control rod drive (CRD) nozzles and stub tube/CRD nozzle repairs involve the following steps:

1. Removal of damaged material through a machining process such as abrasive water jet machining or conventional machining;

2. Replacing the damaged material with upgraded material; and

3. Welding the upgraded material to reattach the components. Spatial limitations have limited this approach to nozzle inside diameters of approximately 1.25″ or larger.

Variations on this general procedure are described in various U.S. patents.

U.S. Pat. No. 5,918,911 teaches that pressure vessel replacement nozzles may be partial or full replacements and the procedure involves machining out the existing nozzle, partially or entirely, possibly adding a sleeve in the machined area and welding in the replacement.

U.S. Pat. No. 5,661,767 teaches that pressure vessel defective nozzles may be partial or full repaired by boring out the existing defect, partially or entirely, and adding a sleeve in the machined area and welding in the replacement.

U.S. Pat. No. 5,367,768 teaches that pressure vessel defective nozzles of inconel 600 may be repaired by mechanically rolling out the defect to enlarge the defective area.

However, the prior art techniques do not teach an effective repair method for small diameter bottom mounted nozzles having an internal diameter of approximately 1.25 inches or less.

### SUMMARY OF THE INVENTION

The present invention addresses repair of bottom mounted nozzles (BMN) on reactor pressure vessels (RPV) and heater penetrations on pressurizers (PZRs), especially nozzle designs that incorporate nozzles with an ID of less than 1.25″.

IAlloy 600 used for such nozzles is susceptible to stress corrosion cracking (SCC) and more nuclear power plant designs utilized Alloy 600 during construction. SCC is a time and temperature related occurrence, and this alloy has been in service for many years across many plant designs in the world. Non-destructive inspection techniques are able to identify SCC on nuclear power plant components and repair methods have been developed to address SCC. Internal Diameter Temper Bead (IDTB) welding is the process used most often for welding the nozzles from the ID. In order to perform remote access IDTB welding, weld vision is preferable. However, as the ID of the nozzle shrinks, the ability of the weld head to perform adequately on thicker sections diminishes. There exists BMN on RPVs and heater penetrations on PZRs which have nozzle thickness to ID ratios that are not conducive to internal access weld repairs for this reason.

The present invention enlarges the original small nozzle bore with a machining process an replaces the nozzle with new nozzle that offers a larger ID for tooling entry therein and itds welding to the vessel bottom. A small nozzle sleeve is inserted into the new nozzle and welded thereto to restore the operability of the nozzle. The sleeve is welded to the replacement nozzle from below (socket or fillet weld). The original nozzle remnant is welded to the sleeve (socket or fillet weld). In the case of a heater penetration, the sleeve of the heater could be overlaid to increase the OD for welding into the increased ID of the penetration.

There are various options for reactor pressure vessel (RPV) and heater penetrations (PZR) repair and they are the following:

RPV Repair Options:

Partial nozzle removal—IDTB repair, dissociated attachment weld (bottom up repair)

Full nozzle removal—IDTB repair, complete attachment weld, anti-ejection feature (bottom up repair/top down anti-ejection nozzle delivery)

PZR Repair Options:

Partial nozzle removal—IDTB repair, dissociated attachment weld (bottom up repair)

Full nozzle removal—IDTB repair, dissociated attachment weld (bottom up repair)

Partial nozzle removal—IDTB repair, dissociated attachment weld, heater modification (no sleeve on component)

Full nozzle removal—IDTB repair, dissociated attachment weld, heater modification (no sleeve on component)

From the foregoing it will be seen that one aspect of the present invention is to provide a small diameter nozzle repair method using internal tube ID welding.

Another aspect is to provide an Inconel Alloy nozzle stress corrosion cracking repair method.

Yet another aspect is to provide a repair method for failed heater penetrations on pressurizers (PZRs).

These and other aspects of the present invention will be more fully understood upon a review of the following description of the preferred embodiment when considered with the accompanying drawings.

### BRIEF DESCRIPTION OF THE DRAWINGS

In the drawings wherein:

FIG. 1 shows the configuration for a bottom mounted small diameter nozzle on a reactor vessel;

FIG. 2 shows a full nozzle replacement of a bottom mounted small diameter nozzle on a reactor pressure vessel as shown in FIG. 1; and

FIG. 3 shows a half nozzle replacement of a bottom mounted nozzle on a reactor pressure vessel shown in FIG. 1.

### DESCRIPTION OF THE PREFERRED EMBODIMENT

Referring now to the drawings and FIG. 1 in particular, a bottom mounted nozzle assembly (10) is shown having a small diameter (1.25 in. or smaller) Inconel Alloy 600 nozzle (12) extending through a section (14) of the reactor vessel bottom. The assembly (10) has a tube (12) welded to the top of the reactor vessel bottom, a section (14) of which is shown, by a weld bead (16) and has a thimble guide tube (18) attached to the bottom end of the tube (12) by a weld bead (17).

The tube (12) material is Inconel Alloy 600 which is susceptible to intergranular stress corrosion cracking (IGSCC). Internal Diameter Temper Bead (DTB) welding is the process used most often for welding the Inconel nozzles from the ID. In order to perform remote access IDTB welding, weld vision is required. As the ID of some of the nozzles are in the 1.25 in or smaller diameters, the ability of the weld head to fit in these tubes is diminished. Thus the BMN on RPVs and heater penetrations on PZRs which have nozzle of the above mentioned ID are not conducive to internal access weld repairs and a new method was needed to perform such repairs. This new method involves the enlarging the original nozzle bore with a machining process such as water jet machining and replacing the nozzle partially or entirely with a replacement nozzle that offers a sufficiently large ID for weld tooling insertion. After welding the new nozzle to the reactor bottom material a small diameter nozzle sleeve is inserted therein and then welded to the new nozzle to restore the operability of the small diameter nozzle. The sleeve is welded to the replacement nozzle from below by either a socket or fillet weld. The original nozzle remnant in a partial nozzle repair is welded to the sleeve also by a socket or fillet weld. In the case of a heater penetration, the sleeve of the heater could be overlaid to increase the OD for welding into the increased ID of the penetration.

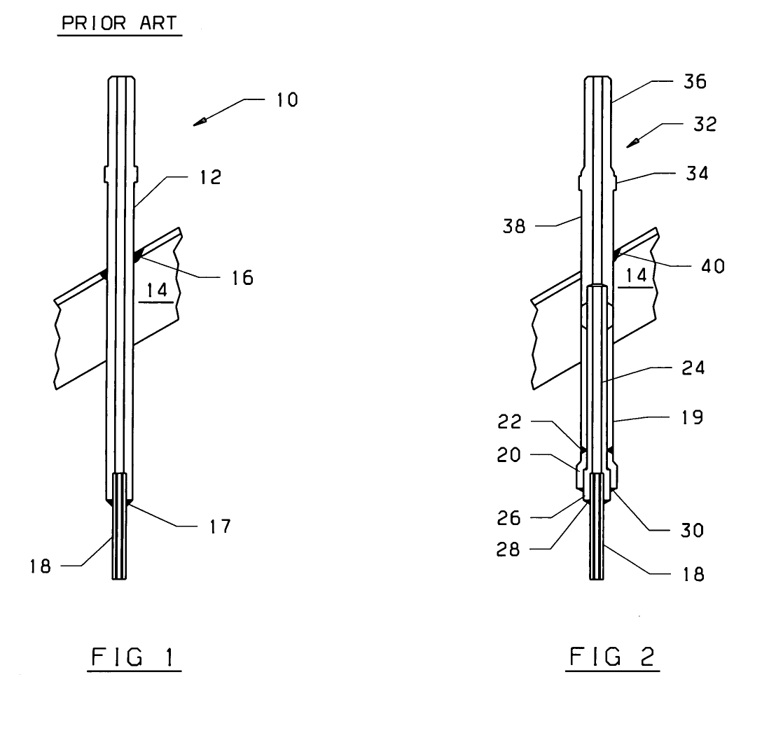

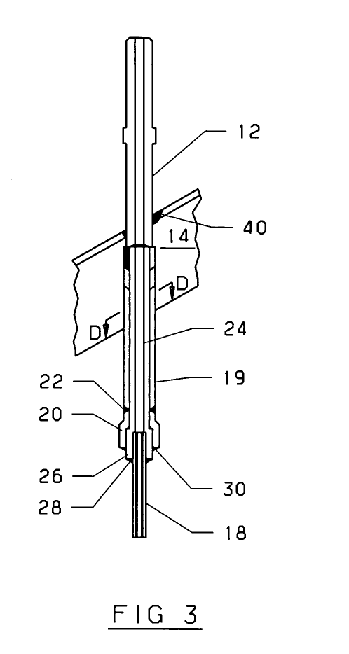

The described method may involve a full replacement of the tube (12) as shown in FIG. 2 or a partial replacement of the tube (12) as shown in FIG. 3.

Referring to FIG. 3 it will be seen that the bottom section of tube (12) has been cut out to form a diameter D-D in the section (14) originally holding that part of the tube (12) that is now significantly larger than that of original tube (12). This was done by machining out the bottom half section of the tube as well as the reactor vessel bottom material by known means leaving the top half section of tube (12) intact and located partially within the section (14). A replacement nozzle section (19) having an inside diameter equal to the outside diameter of tube (12) is now inserted into the machined diameter D-D of section (14) and is welded to the reactor vessel base material of section (14) with an IDTB weld since the ID of the replacement nozzle (19) is now sufficient to provide access for IDTB weld tooling. A safe end (20) of the tube was welded by a weld bead (22) to the outside end of the replacement nozzle (19) prior to its insertion into the section (14) to abut the internally located end of the original small diameter tube (12). The safe end (22) provides a similar metal weld joint for full welding of the replacement nozzle (19) to a replacement sleeve section (24) when it is inserted into the nozzle (18) abutting the tube (12). The replacement sleeve (24) has an ID equal to the original small diameter tube (12) and has an enlarged end section (26) which extends beyond the safe end (20) and has its OD matching the ID of the safe end (20). The ID of the end (26) matches the OD of the original thimble guide tube (18) which is pressed therein and welded thereto by a weld bead (28). The end (26) of the replacement sleeve (19) is welded to the safe end (20) by a weld bead (30). Thus the integrity of replacement assembly from any water leakage is provided.

Referring now to FIG. 2 it will be seen that additionally to the bottom tube (12) replacement shown in FIG. 3 and repeated in FIG. 2 , the top section of the tube (12) could also be replaced with an anti-ejection top nozzle replacement (32) having an anti-ejection feature (34). It will be noted that for such a full nozzle replacement the top section of the replacement nozzle (19) is beveled but all other aspects are identical.

Due to the additional anti-ejection feature (34) on the upper nozzle replacement tube (32) it must be delivered from the top of the vessel down into the nozzle bore.

With the full nozzle replacement option, an additional chamfering step is added to remove most of the original weld (16) between vessel and the nozzle. By removing weld material (18) the crack size decreases which will provide longer life for the modification.

The upper nozzle replacement assembly (32) has a top section (36) identical to the tube (12) but has an enlarged OD section (38) which fits over the sleeve (24) and is welded to the section (14) by a weld bead (40). As was mentioned, this larger end section (35) required a machining of the upper part of section (14).

Thus it is seen that the problem of small diameter nozzles which cannot be welded from the ID with temper bead weld repairs due to spatial limitations is overcome by removing the nozzle with a machining process, overboring the original nozzle to provide a larger ID and space for IDTB tooling allows for internal access weld repairs. The original ID of the nozzle can be reestablished with a sleeve that is welded (socket weld or fillet weld) to the new nozzle from the OD. This eliminates the need for a weld pad around the nozzle and simplifies the motion control involved with the welding process for nozzle mounted on spherical heads (i.e. pressurizers and reactor vessels).

BMN Inconel nozzle repair can also be achieved by welding a pad to the base material (reactor vessel or pressurizer), removing the damaged material, replacing the material with SCC resistant material, and welding the resistant material to the previously placed weld pad. However, the tooling for this approach is more costly and more difficult to implement than the internal access repair approach (IDTB) described.

It will be understood that certain obvious modifications and details have been deleted herein for the sake of conciseness and readability but that all such are fully intended to fall within the scope of the following claims.

We claim:

1. A method of repairing a small diameter reactor vessel mounted nozzle using internally located weld tooling comprising the steps of:
machining the original nozzle to form an opening in the reactor vessel having an ID larger than the OD of the original nozzle;
inserting a replacement tube into the machined opening having aN ID sufficient to allow internally located welding machinery therein;
welding the replacement tube to the reactor vessel material;
inserting a new small diameter nozzzle having an ID identical to the original nozzle in the welded replacement tube; and
welding the new nozzle to the replacement tube to restore the operability of the original nozzle.

2. A method of repairing a small diameter reactor vessel mounted nozzle as set forth in claim 1 wherein the replacement tube is made of Inconel 600 alloy material and the step of welding the replacement tube is done using IDTB welding apparatus located inside the replacement tube.

3. A method of repairing a small diameter reactor vessel mounted nozzle as set forth in claim 2 wherein the step of machining the original nozzle comprises the machining of a bottom section of the original nozzle to leave a portion located inside the wall of the pressure vessel.

4. A method of repairing a small diameter reactor vessel mounted nozzle as set forth in claim 3 further including the step of machining the remaining portion of the original nozzle and inserting a top replacement tube into the reactor vessel and welding it thereto to provide a complete replacement of the original nozzle.

5. A method of repairing a small diameter reactor vessel mounted nozzle as set forth in claim 4 wherein the top replacement tube has an anti-ejection member and is inserted from the inside of the reactor vessel.

6. A method of repairing a small diameter reactor vessel mounted nozzle as set forth in claim 5 wherein the machining includes the machining of the reactor vessel to remove al of the weld bead holding the top section of the original tube to the reactor vessel.
